(19) United States
(12) Patent Application Publication
(10) Pub. No.: US 2011/0273278 A1
(43) Pub. Date: Nov. 10, 2011

(54) System and Method for Transmitting Information

(76) Inventors: Tod Edward Kurt, Pasadena, CA (US); Michael Kuniavsky, San Francisco, CA (US)

(21) Appl. No.: 13/103,978

(22) Filed: May 9, 2011

Related U.S. Application Data
(60) Provisional application No. 61/332,665, filed on May 7, 2010.
(60) Provisional application No. 61/422,818, filed on Dec. 14, 2010.

(51) Int. Cl. G06K 7/01

(52) U.S. Cl. 340/10.3

(57) ABSTRACT

A system and method for transmitting information within a space, including sensory modules that each include a data signal receiver and an output element; a first signal emitter that emits a data signal of a first broadcast breadth that directs a signal with a first information set on the operation of the output element to a first portion of the space to a first sensory module within the first portion and a signal with a second information set on the operation of the output element to a second portion of the space to a second sensory module within the second portion; and a second signal emitter that emits a data signal of a second broadcast breadth larger than the first broadcast breadth with a third information set with information on the implementation of the first and second information sets to both the first and second portions of the space.

### CROSS-REFERENCE TO RELATED APPLICATIONS

This application claims the benefit of U.S. Provisional Application No. 61/332,665, filed on 7 May 2010 and titled “System and Method for Enhancing User Experience” and U.S. Provisional Application No. 61/422,818, filed on 14 Dec. 2010 and titled “System and Method for Transmitting Information,” which are both incorporated in their entirety by this reference.

### BACKGROUND

Information is distributed wirelessly in many forms, such as radio broadcasts, cellular signals, WiFi signals, and Bluetooth signals. However, information distributed using these wireless protocols are either broadcasted to all devices with a suitable receiver or is transmitted to a particular device. To transmit to a particular device, both the transmitter and the receiver must use an encoding or “pairing” scheme (e.g., cellular signals, password-protected WiFi signals, and Bluetooth signals). This encoding scheme must be known, by both the transmitter and the receiver, before the transmission to a particular device can be accomplished. Additionally, to transmit information that is dependent on the location of the receiving device, substantially complicated location mechanisms are employed, for example, global positioning system (GPS) and/or triangulation. Such locating methods may not be able to locate devices to the accuracy that may be desired, for example, within a few feet. In some situations, it may be useful to transmit information to a particular device based on the location of the particular location of the device that may be substantially proximal to another device without the use of an encoding or “pairing” scheme. This invention provides such new and useful system and method.

### BRIEF DESCRIPTION OF THE FIGURES

FIG. 1 is a schematic representation of the system of the preferred embodiments for transmitting information in a space in a first usage scenario.

FIG. 2 is a schematic representation of the method of the preferred embodiments for transmitting information in a space.

FIG. 3 is a schematic representation of variations of the sensory module.

FIG. 4 is a schematic representation of a variation of the system with a central control.

FIG. 5 is a schematic representation of the system of the preferred embodiments applied at a street intersection.

FIG. 6 is a schematic representation of the system of the preferred embodiments applied along a street.

FIG. 7 is a schematic representation of the system of the preferred embodiments applied in a substantially wide field.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

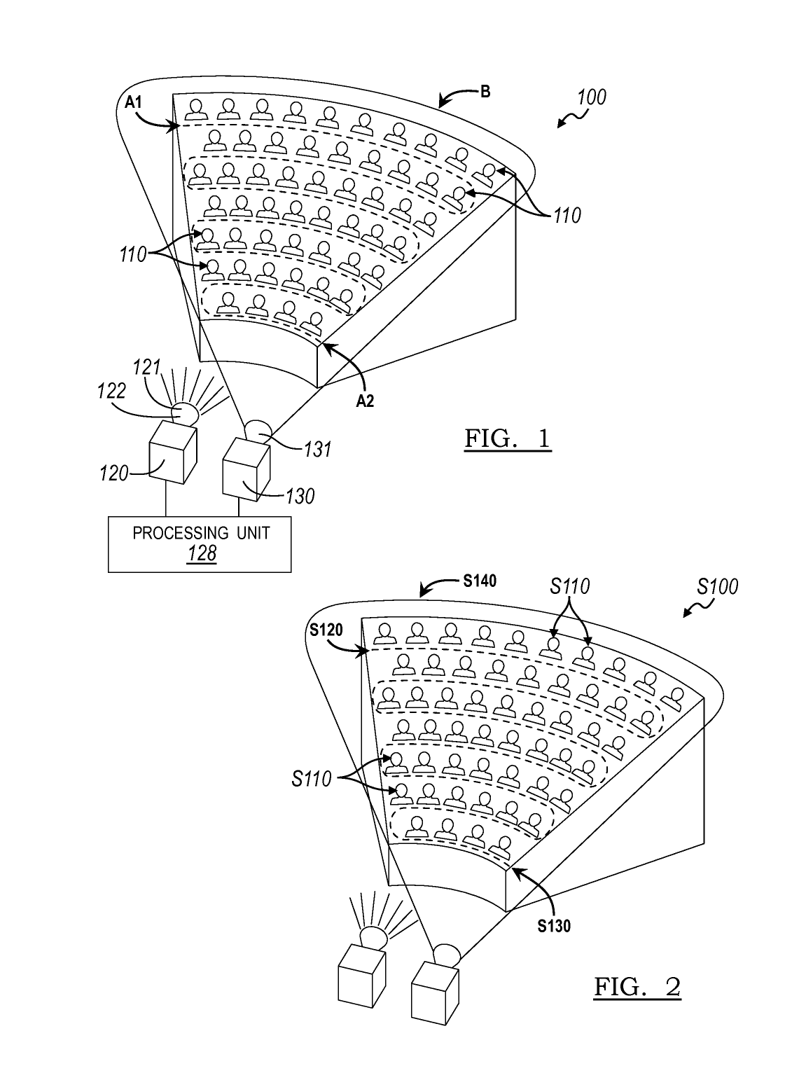

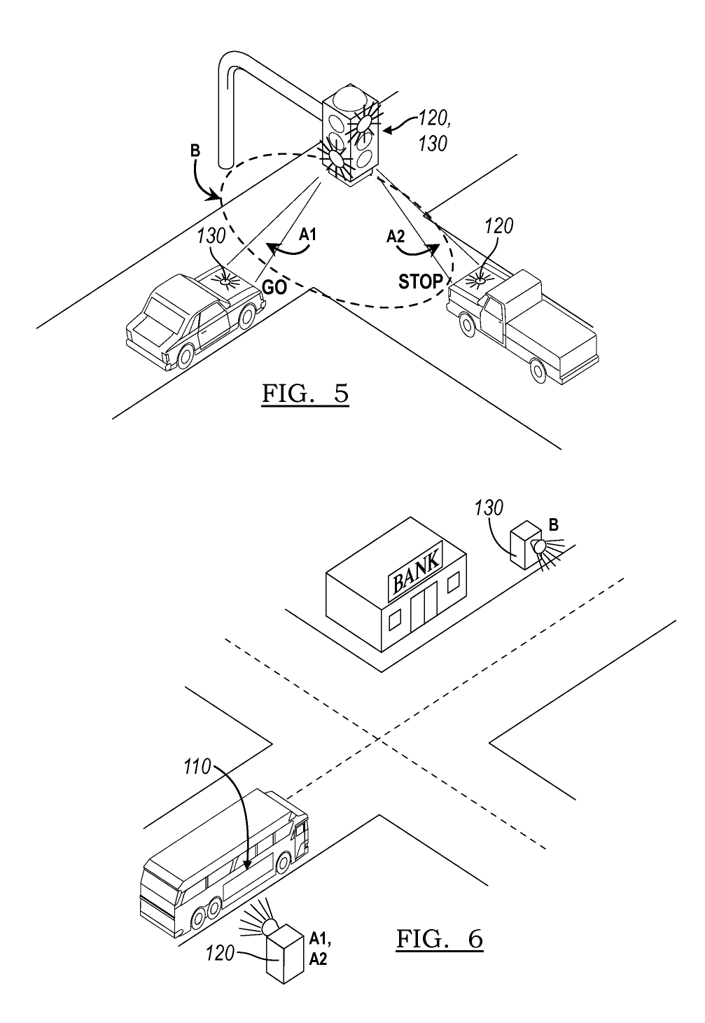

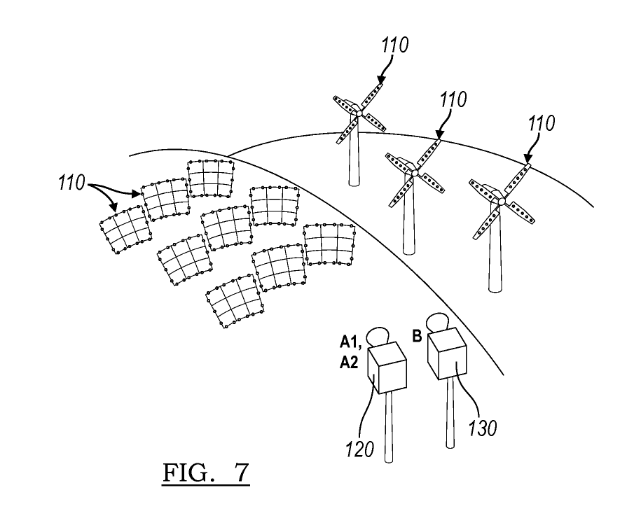

As shown in FIGS. 1 and 5-7, the system 100 for transmitting information within a space preferably includes a plurality of sensory modules 110 that each include a data signal receiver 112 and an output element 114 and that are arranged substantially within the space, a first signal emitter 120 that emits a data signal of a first broadcast breadth and a second signal emitter 130 that emits a data signal of a second broadcast breadth substantially larger than the first broadcast breadth. The first signal emitter 120 preferably includes a direction modifier 122 that directs (1) a data signal including a first information set to a first portion of the space to be received by a first sensory module substantially within the first portion (information set A1) and (2) a data signal including a second information set to a second portion of the space to be received by a second sensory module substantially within the second portion (information set A2). The second signal emitter 130 preferably directs a data signal including a third information set (information set B) to both the first portion and the second portion to be received by both the first and second sensory modules. The first and second information preferably include instructions on the operation of the first and second sensory modules, respectively, and the third information set preferably includes instructions on the implementation of the first and second information sets. The first and second signal emitters 120 and 130 preferably cooperate to transmit location specific information to the plurality of sensory modules 110, in particular, information regarding the operation of the sensory modules 110 based on the location of the sensory module 110 within the space. The space in which the system 100 of the preferred embodiments is arranged may be an event space as shown in FIG. 1 such as an auditorium, a theater, or a stadium, but may alternatively be any other suitable type of defined space, such, a street intersection, as shown in FIG. 5, a field, as shown in FIG. 7, a factory manufacturing line, inside a building, along the facade of a building, and/or a city (for example, the first and second emitters may be arranged in a tall tower that can broadcast to portions of the city).

The system 100 of the preferred embodiments allows for selective information to be communicated to selective sensory modules 110 based on the location of the sensory modules 110 without the need for complex systems and/or methods for device location, device identification, and/or pairing with the device. The first and second signal emitters 120 and 130 may alternatively be thought of as providing a first level of information and a second level of information, respectively, to the sensory modules 110, where the combination of the first and second levels of information provides a substantially complete set of location based operation instructions to the sensory modules 110. The first level of information is preferably specific to the location of the sensory module 110 (for example, instructions on the operation of a particular sensory module 110 in a particular location in the space) and the second level of information is nonspecific to the location of the sensory module 110 (for example, the timing instructions to implement the location specific instructions provided in the first level of information). However, any other suitable type of information set may be provided.

As shown in FIG. 2, the method S100 for transmitting information within a space preferably includes arranging a plurality of sensory modules that each include a data signal receiver and an output element within the space Step S110, emitting a data signal with a first broadcast breadth with a first information set to a first portion of the space to be received by a first sensory module substantially within the first portion Step S120, emitting a data signal with the first broadcast breadth with a second information set to a second portion of the space to be received by a second sensory module substantially within the second portion Step S130, and emitting a data signal of a second broadcast breadth substantially larger than the first broadcast breadth with a third information set to both the first and second portions of the space to be received by the first and second sensory modules Step S140. The first and second information sets preferably include information on the operation of the output element of the first and second sensory modules, respectively, and the third information set preferably includes instructions on the implementation of the first and second information sets. However, any other suitable type of information set may be broadcasted to the sensory modules.

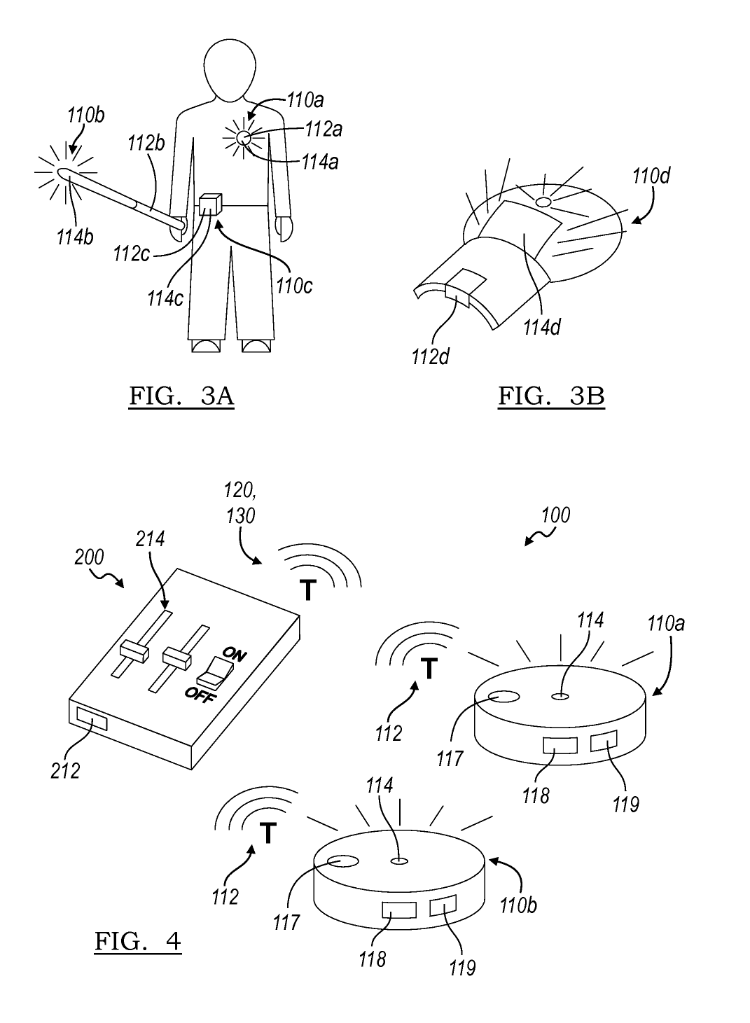

The sensory module 110 functions to receive information from the first and second emitters 120 and 130 and to provide sensory stimulation to a user, for example, vision, touch, hearing, smell, and/or taste. As shown in FIGS. 3 and 4, each sensory module 110 preferably includes a receiver 112 that receives the data signal from the first and second signal emitters 120 and 130 and an output element 114 that stimulates a sense that is detectable by the user and/or a second user viewing the sensory module 110. The sensory module 110 may also include a power source 119 that provides power to the output element 114 and/or the receiver 112, as shown in FIG. 4. In a first example, as shown in FIG. 3, the output element 114 may be a light emitter, as shown in sensory modules 110a and 110b. In a second example, the output element 114 may be a vibration element that produces a vibration that can be felt by the user, as shown in sensory module 110c. In a third example, the output element 114 may be a display that displays an image, as shown in sensory module 110. In this third example, the display may not be seen by the user of the particular sensory module 110 but may be seen by a user that is viewing the user of the particular sensory module 110. However, the output element 114 may be any other suitable type of sensory stimulating element. The output element 114 is preferably of a type that may be actuated. In a first example, the output element 114 may have an on and off state that may be controlled, such as a light on and light off, vibration on and vibration off, sound on and sound off, or any other suitable type of on and off state. In a second example, the output element 114 may have operation modes that may be selected, such as green light mode and red light mode, high intensity vibration and low intensity vibration, loud sound and soft sound, or any other suitable type and/or number of operation modes. However, the output element 114 may be of any other suitable type.

The sensory module 110 may be any suitable type of form factor, as shown in FIG. 3. For example, the sensory module 110 may be a blinking badge that may be worn on a user, a multi colored light wand that may be held by a user, a vibrating badge that may be worn by the user, or a hat with a display that may be worn by the user. Alternatively, the sensory module 110 may be mounted onto the interior of a vehicle, as shown in FIG. 5, the exterior of a vehicle, as shown in FIG. 6, a series of lights outdoors, decorative lights on a house, or any other suitable type of arrangement.

The sensory module 110 may also include a storage device 118 that functions to store information sets, as shown in FIG. 4. In a first variation, the storage device may be pre-loaded with a series of information sets that may be referenced by data signal broadcasted by the first emitter 120. For example, the storage device of each sensory module 110 may be pre-loaded with information sets I, II, and III. The data signal broadcasted by the first signal emitter 120 may function to instruct the first sensory module 110 to retrieve information set I and a second sensory module 110 to retrieve information set II and the data signal broadcasted by the second signal emitter 130 may function to instruct each sensory module 110 to implement whichever information set was retrieved based on the instructions provided by the first signal emitter. In a second example, the storage device of each sensory module 110 may function to store the information sets received from the first signal emitter 120. In this example, the storage device may be thought of as a temporary data storage device such as RAM or flash memory that may be deleted and/or rewritten whenever a new information set is received from the first signal emitter 120. In this example, the second signal emitter 130 may function to instruct the sensory modules 110 to implement whatever information is stored within the storage device. The storage device may store any other suitable number of sequences, size of sequences, or any other suitable type of sequence. However, any other suitable usage of the storage device of the sensory module 110 may be used.

The sensory module 110 may also include a module processor that functions to interpret the data signal received from the first and second signal emitters 120 and 130 and to implement the interpreted data signal through the output element 114. Alternatively, the data emitted by the first and second signal emitters 120 and 130 may already be processed to be implementable by the output element 114 without further processing by the sensory module 110. However, any other suitable arrangement of the processing of the data signal into information implementable by the output element 114 may be used.

The first emitter 120, as described above, functions to provide a first information set to a first sensory module 110 located substantially within a first portion of the space and a second information set to a second sensory module 110 located substantially within a second portion of the space. The first and second information sets are preferably stored in the respective sensory modules 110 and are preferably later referenced by the third information set of the second signal emitter 130. As described above, the first and second information sets preferably include information on the operation of the output element 114 of the first and second sensory modules 110, respectively. The information set may include one of a variety of different types of instructions. In a first variation, the first and second information sets may include a timing sequence for the actuation of the output element 114, for example, the first information set may include a first timing sequence of turning on and off an output element 114 that includes a light emitter and the second information set may include a second timing sequence of turning on and off the light emitter. In this variation, each of the sensory modules 110 preferably include a timing module that is substantially synchronized with the timing modules of other sensory modules 110. In a second variation, the first and second information sets may include instructions on the operation mode to actuate, for example, the first information set may include instructions to actuate the green operation mode of a colored light emitter and second information set may include instructions to actuate the red operation mode of a colored light emitter. In a third variation, the first and second information sets may include instructions for a sequence of images to display on an output element 114 that is a display. The first and second information sets may alternatively be a combination of the variations described above, for example, the first and second information sets may include a time sequence for the actuation of a combination of operation modes of the output element 114, for example, a time sequence for the actuation of various color modes in a colored light emitter. However, the first and second information sets may include any other suitable type of instruction to operate the output element 114.

The first signal emitter 120 is preferably of an emitter type that emits detectable data signals that are preferably invisible to the human eye. The data signal emitted by the first emitter 120 is preferably directional, in particular, the data signal preferably maintains a particular direction when directed at that particular direction, such as those seen television remotes. The data signal is preferably of an electromagnetic wave such as an infrared signal, but may alternatively be an ultrasonic signal, laser, or any other suitable type of signal. Because certain directional signals (in particular, electromagnetic wave signals and ultrasonic signals) may bounce off of surfaces and reflect towards a direction that was not of the original desired direction, the receiver 112 of the sensory module 110 is preferably able to discern between a direct signal and an unintentional reflected signal. In a first example, because reflected signals are generally of lower power than direct signals, the receiver 112 may only acknowledge and/or detect signals of a particular strength threshold. In a second example, because reflected signals take a longer path to reach a particular receiver 112, the receiver 112 may be configured to acknowledge the earliest arriving signal and ignore a later, possibly reflected, signal. In a third example, the first signal emitter 120 (and second signal emitter 130) may emit a signal that is polarized in a particular direction. Because reflection generally changes the polarity of a signal, the receivers 112 may be configured to only receiver signals of a particular polarization. In a fourth example, the emitters may function to emit the signal towards the first and second portion of the space in varying patterns to change the possible reflection patterns to decrease the number unintended receivers 112 that receive the reflected signal. In this example, the emitters 120 and 130 may function to scan the space to detect receivers that unintentionally received the signal and may determine an alternative path to emit the next signal that would substantially prevent the detected unintended receivers. In the variation where the output element 114 is a light, the first and/or second emitters 120 and 130 may visually detect the light output of the sensory module 110 (for example, by taking an image of the light output of the sensory modules 110 within the space and analyzing the light output based on the location of each sensory module 110), or the sensory module 110 may include a signal reflector that reflects the received signal back at the emitters. The fourth example may also include a feedback method that uses the scanned information to change the manner in which the emitters emit a signal to the sensory modules 110 in the space. The scan may also be used to differentiate between signals from multiple emitters (for example, in an example where there is more than one first signal emitter 120). In a fifth example, the first and/or second signal emitters 120 and/or 130 may include signal receivers and each sensory module 110 may include a signal emitter that communicates with the first and/or second signal emitters 120 and/or 130. In this example, the sensory modules 110 may communicate back to the first and/or second signal emitters 120 and/or 130 to confirm that each sensory module 110 received the correct information sets. For example, when a sensory module 110 receives an information set, the same information set (or a truncated version) may be sent back to the first and/or second signal emitter 120 and/or 130 to be matched with what was originally sent to that particular sensory module 110. However, any other suitable method to discern between a direct signal and an unintentional reflected signal may be used.

The first emitter 120, as described above, preferably includes a direction modifier 122 that functions to direct the signal to a desired location within the space. The first emitter 120 preferably also includes a signal output head 121, for example, an infrared emitting LED bulb that provides the output of the first signal emitter 120. The signal output head 121 may also include lenses that focus the signal to a particular location and/or influences the magnitude of the signal breadth. In particular, the lenses may function to decrease the magnitude of the signal breath to decrease the number of sensory modules 110 that receive a particular data signal broadcasted to a particular portion of the space to substantially one. Alternatively, the lenses may function to vary the magnitude of the signal breadth to reach a desired number of sensory modules 110. The variation of the lenses may be dynamic such that, during use, the first signal emitter 120 may change the breadth of the signal depending on the desired breadth. However, any other suitable lens arrangement may be used. The direction modifier 122 is preferably an actuator that functions to move the signal output head 121 of the first signal emitter 120. The direction modifier 122 preferably allows for substantially high articulation of the signal output head 121 to increase the number of directions towards which to emit the data signal and to increase the number of locations within the space that may be reached by a direct signal. Alternatively, reflected signals may be used to reflect the signal to reach particular locations that are otherwise unreachable by direct signal. In this variation, the sensory module 110 preferably detects these desired reflected signals. However, any other suitable system and/or method to direct the signal emitted by the first signal emitter 120 may be used.

As shown in FIG. 6, the first signal emitter 120 may alternatively emit a substantially stationary data signal and the plurality of sensory module 110 may be moved to a location to receive the substantially stationary data signal, for example, as shown in FIG. 6, the sensory module 110 may be mounted onto a moving vehicle to receive the data signal emitted by the first signal emitter 120. However, any other suitable arrangement of the first signal emitter 120 may be used.

The second signal emitter 130, as described above, is substantially similar to the first signal emitter 130. The second signal emitter 130 functions to provide a third information set to sensory modules 110 located substantially within the first and second portions of the space. The third information set preferably includes an implementation information set that instructs the sensory modules 110 that receive the signal on the implementation of the instructions received from the first signal emitter 120, regardless of whether the sensory module 110 received the first or the second information set. The implementation information set preferably commonly references the instructions that were received from the first signal emitter 120 across all of the sensory modules 110 that receive the third information set. In other words, a first sensory module 110 received a first information set from the first signal emitter 120 and a second sensory module 110 received a second information set from the first signal emitter 120 that both receive the third information set from the second emitter 130 will both recognize the third information set as implementation instructions for the information set received from the first signal emitter 130. In this way, the first and second sensory module 110 may operate in a synchronized manner, but each may execute a different set of instructions. The second signal emitter 130 may alternatively be thought of as a “synchronizer” to synchronize the implementation of instructions received by each of the sensory modules 110. As described above, common referencing may be achieved by storing the information received from the first signal emitter 120 in a “to be executed” memory that is then referenced by the third information set. Alternatively, the first information set may be stored in a first sensory module as “Sequence A” and the second information set, different from the first information set, may be stored in a second sensory module 110 also as “Sequence A.” The third information set may then instruct the implementation of “Sequence A.” However, any other suitable common referencing method may be used.

The implementation information set in the third information set from the second signal emitter 130 may be one of a variety of types of instructions. In a first variation, the implementation information set may include instructions to implement the information set received from the first signal emitter 120 substantially immediately, in other words, the implementation information set functions as a “trigger” to implement the information set received from the first signal emitter 120. In a second variation, the implementation information set may include instructions on when to implement received information set, the sequence in which to implement the received information set, and/or any other suitable time delayed instruction. In this second variation, the sensory module 110 preferably functions to store the time information received from the third information set and preferably operates the output element 114 based on the timing provided. As described above, the sensory modules 110 that receive a timing based instruction set preferably include a timing module that is substantially synchronized with the other sensory modules 110 to allow substantially synchronized implementation of the desired information sets. However, any other suitable type of information may be provided in the third information set from the second signal emitter 130.

The second signal emitter 130 is preferably of an emitter type that is substantially similar to the first emitter type 120, for example, the second signal emitter 130 preferably emits a signal of the type that is substantially similar to the first emitter type 120 to allow the receiver 112 of the sensory module 110 to interpret the signal in a substantially similar way. Because the signal from the second signal emitter 130 is preferably broadcasted to all of the sensory modules 110 that are to receive the signal at one time, as described above, the data signal emitted by the second signal emitter 130 preferably has a signal breadth that is substantially larger than the signal emitted by the first signal emitter 120 to allow the signal to be received by sensory modules 110 within both the first and second portions of the space. The signal breadth is preferably large enough to reach all of the sensory modules 110 substantially within the space, such as a floodlight type breadth, as shown in FIG. 1, but may alternatively be any other suitable signal breadth. The second signal emitter 130 preferably includes a signal output head 131 that, such as an infrared emitting LED bulb that provides the output of the second signal emitter 120. The signal output head 131 of the second signal emitter 130 may also include a lens that enlarges the signal breadth of the second signal emitter 130. Alternatively, the signal output head 131 may be configured to have a substantially large signal breadth. However, any other suitable signal breadth defining method may be used for the second signal emitter 130.

The first and second signal emitters 120 and 130 may be separate units, as shown in FIGS. 1, 6, and 7, but may alternatively be a single unit, as shown in FIG. 5. In this variation, the single signal emitter may include a first and second signal output head that are each responsible for emitting as the first and second emitters 120 and 130, respectively. Alternatively, the single signal emitter may include a single signal output head that is coupled to a direction modifier with interchangeable and/or adjustable lenses to adjust the signal breadth depending on whether the signal emitter is operating as the first signal emitter 120 or the second signal emitter 130. Alternatively, multiple first signal emitters 120 and/or multiple second signal emitters 130 may be used. However, any other suitable arrangement of the first and second signal emitters 120 and 130 may be used.

The system 100 of the preferred embodiments may also include a processor 128, as shown in FIG. 1, that determines the first, second, and/or third instruction sets to be sent to the sensory modules 110. The processor 128 may be directly coupled to the first and second emitters 120 and 130 through a wired connection, but may alternatively communicate with the first and second emitters 120 and 130 through a wireless connection. For example, through using ZigBee, Bluetooth, Wireless LAN, or any other suitable type of wireless signal. The processor 128 may communicate directly with the emitters, but may alternatively communicate with the emitters 120 and 130 indirectly, for example, through the Internet or through any other suitable intermediary communication network. The processor 128 may be pre-programmed with first, second, and/or third instruction sets that are to be sent to the sensory modules 110 at a particular timing. Alternatively, the system 100 of the preferred embodiments may also include a central control 200, as shown in FIG. 4, that functions to receive a user input on the first, second, and/or third instruction sets. In this variation, the processor 128 is preferably coupled to the central control 200 to communicate instructions from the central control 200 to the first and second emitters 120 and 130. In a first variation, the central control 200 may include a user interface 214 that functions to allow a user to indicate the desired first, second, and/or third instruction set to be sent to the sensory modules 110. The user interface 214 may also function to allow a user to indicate the timing for the first, second, and/or third instruction sets to be sent to the sensory modules 110 and/or the portions of the space to emit the first, second, and/or third instruction sets. The user interface 214 may be a physical interface and may include switches to indicate a desired state of the output element 114, representations of the space with selectable regions to indicate the desired portions of the space to emit the first, second, and/or third instruction sets, a slider to indicate the desired output intensity of the output element 114, or any other suitable type of user input element. Alternatively, the user interface 214 may be a digital software interface that allows the user to input instructions through a computer or any other suitable device. In this variation, the processor 128 preferably functions to interpret the instructions provided by the user through the user interface 214 and to first and/or second signal emitters 120 and 130 to transmit the desired instruction sets to the designated sensory modules 110. However, the central control 200 may include any other suitable type of control for the first and/or second emitters 120 and 130 and/or the sensory modules 110.

The space may be an event space and may include a control system that controls the user experience provided by the space. In this variation, the central control 200 of the system 100 is preferably integrated into the existing control system of the user experience. This may allow for a centralized control system for the user experience provided by both the space and the system 100. For example, the space may include a light control panel that controls the lighting within the space when providing a user experience, such as spot lights or wall lights in a theater. In this example, the central control 200 is preferably integrated into the existing light control panel. However, the central control 200 may be integrated into any other suitable type of control system. In the version of the central control 200 that includes a user interface 214, the user interface 214 is preferably integrated into the existing control system for the space. The user interface 214 is preferably similar to the existing user interface of the control system for the user experience, for example, if the existing control system for the user experience includes sliders for light intensity, the user interface 214 of the central control 200 preferably also includes sliders for intensity of the output of the output element 114. However, any other suitable arrangement between the control system of the space and the central control 200 may be used. Alternatively, the central control 200 may be a separate unit from the control system of the space. However, any other suitable arrangement between the central control 200 and the control system of the space may be used.

The control system of the user experience and the central control 200 preferably communicate with each other to determine the first, second, and/or third instruction sets to the sensory modules 110. In the above example where the control system of the space includes control for the lighting of the space, the control system may include programming to control the sensory modules 110 along with the lighting sources in the environment and the control system may communicate instructions to the central control 200. In a second example, the central control 200 may communicate the state of the sensory modules 110 to the control system. The control system may then take the information provided by the central control 200 to manipulate the other lighting sources in the environment. However, any other type of information and/or instructions may be communicated between the central control 200 and the control system.

In the variation where the central control 200 and the control system of the user experience are separate units, the central control 200 may include a plug that interfaces with a plug on the control system to allow communication between the central control 200 and the control system of the space. For example, the control system may be a computer that includes a Universal Serial Bus (USB) interface and the central control 200 may include a plug that interfaces with the USB and communicates directions from the central control 200 to the control system and vice versa. Alternatively, the central control 200 may communicate with the control system of the user experience through a wireless protocol, for example, WiFi or Bluetooth. However, any other suitable communication between the central control 200 and the control system of the space may be used.

Each of the sensory modules 110 may also include a sensor 117 that produces a signal based upon the environment of the sensory module 110 that may be used to adjust the output of the output element 114 of a particular sensory module 110. For example, the sensor 117 may be an accelerometer. When an increased acceleration of the sensory module 110 is detected, the processor 128 may instruct the output element 114 to emit a higher intensity of output (for example, light). This provides two layers of control of the sensory module 110: The first, second, and/or third instruction set may instruct a sensory module 110 to emit light and, while the sensory module 110 is emitting light, an increased acceleration detected by the sensor 117 may instruct the sensory module 110 to emit a stronger intensity light, thus providing to the user the feeling that their actions change their environment, which may enhance their experience. The sensor 117 may also function to detect the state of a neighboring sensory module 110. For example, the sensor 117 may detect the light intensity and/or pattern of the neighboring sensory module 110 and emulate the light intensity and/or pattern. However, any other suitable sensor or sensor response may be used.

As described above, each sensory module 110 may also include a signal emitter. In this variation, the signal emitter of the sensory module 110 may transmit the state of the sensory module 110 as detected by the sensor 117 to the first and/or second emitters 120 and 130, the processor 128, and/or the central control 200. In this variation, the detected state of the sensory module 110 may be used to change the first, second, and/or third instruction sets. For example, if the acceleration of a particular sensory module 110 is detected to be high, the first, second, and/or third instruction sets may be adjusted to instruct that particular sensory module 110 to emit a different type of light. However, any other suitable adjustment to the first, second, and/or third instruction sets may be used.

### Exemplary Usage Scenarios

The system 100 and method S100 of the preferred embodiments may be used in any suitable usage scenario for the transmission of information within a space. In a first exemplary usage scenario, as shown in FIG. 1, the system 100 and method S100 of the preferred embodiments is applied to a stadium or auditorium space. In this exemplary usage scenario, the sensory modules 110 are given to guest/audience members of the audience. As the audience assumes their seat or standing positions within the stadium, the first signal emitter 120 will emit a series of information sets to the sensory modules 110 arranged among the audience. The first signal emitter 120 may broadcast the information sets in pattern that targets each portion of the audience space in sequence, as shown by line A1-A2 in FIG. 1. In this variation, the direction modifier 122 preferably moves the signal output head 121 at a particular speed along each row of audience members and the output information set is changed at a rate that matches the speed of the signal output head 121 such that subsequent sensory modules 110 may receive different information sets. However, any other suitable pattern may be used. The signal from the first signal emitter 120 is preferably substantially focused to reach one audience member and his or her sensory module 110 at one time, such that sensory modules 110 will receive information sets that are unique based on the location of the audience member within the larger audience. Alternatively, the signal may be focused to reach more than one sensory module 110 at one time, for example, a group of audience members. As described above, the signal breadth may be changed during use. After the first signal emitter 120 has broadcasted information sets to the sensory modules 110 within the space, the second signal emitter 130 than broadcasts implementation instructions to each sensory module 110 substantially all at one time, as shown in floodlight B in FIG. 1, thus synchronizing the implementation of the instructions received from the first signal emitter 120 for all of the sensory modules 110.

Within an audience stadium or auditorium space, there may be a multitude of uses for the information transmitted by the system 100 and method S100. For example, an audience member may be selected to be a winner of a contest based on the location of the seat and the information set that is broadcasted to that particular seat location will contain a win-indication sequence while an audience member in the next seat over is broadcasted a no-win-indication sequence by the first signal emitter 120. Alternatively, in the variation where the sensory module 110 includes a sensor 117 to detect the state of the sensory module 110, the winner may be selected based on the state of the sensory module 110, for example, the winner may be selected if the acceleration of the sensory module 110 is substantially high, indicating that the user is shaking the sensory module 110 substantially vigorously. However, any other suitable selection for a winner may be used. The second signal emitter 130 may then broadcast a “reveal winner” implementation instruction to all of the sensory modules 110 that instruct each sensory module 110 to implement the indication sequence received from the first signal emitter 120. The audience member that received the win-indication sequence will be notified of his or her win. In another example, the sensory modules 110 may be colored light emitters. The first signal emitter 120 may broadcast a series of information sets that include instructions on the color and/or timing of different colors to emit from each sensory module 110. The second signal emitter 130 may then broadcast a “begin sequence” implementation, and the sensory modules 110 will begin to emit light based on the instructions received from the first signal emitter. In this example, the sensory modules 110 may function as pixels in a large screen that is formed by all of the audience members with the transmitted sensory modules 110. By broadcasting information based on the location of the device, such a large and synchronized screen may be formed regardless of the audience members switching seats or moving around the auditorium. When broadcasting information based on the identity of the device itself rather than the actual location of the device, an audience member carrying the device may move from one side of the auditorium to another, resulting in the “pixels” of the large screen to be scattered in an unknown arrangement. The system 100 of this first exemplary usage scenario may also cooperate with an augmented reality device to provide an additional experience to a user viewing the plurality of sensory modules 110. For example, the light output of a particular sensory module 110 may be used as a fiducial marker for an augmented reality device. While a user without an augmented reality device may see a composite image from the light output of a plurality of sensory modules 110, a user watching the plurality of sensory modules 110 through an augmented reality device may see an image that is overlayed over the plurality of sensory modules 110 and is positioned based on the location of the light output of the particular sensory module 110. In this example, a user may experience a more detailed and/or embellished image through an augmented reality device based on the location of the fiducial marker relative to the user and/or the other sensory modules 110. The augmented reality device may also detect the state of the particular sensory module and adjust the provided augmented reality experience based on the state of the particular sensory module 110. However, any other suitable use of the system 100 and method S100 of the preferred embodiments within an auditorium or stadium space may be used.

In a second exemplary usage scenario, as shown in FIG. 5, the users are in vehicles that are at a traffic intersection and the sensory modules 110 are located inside the vehicle and visible to the user. During certain weather conditions or sunlight conditions, the actual color of the light at the intersection may be difficult to see. Thus, the sensory modules 110 distributed to users in vehicles that are allowed to pass through the intersection (the user has a green light) will be instructed to mirror the traffic light and emit a green light while sensory modules 110 distributed to users in vehicles that are to wait (the user has a red light) will be instructed to mirror the traffic light and emit a red light. The light that the sensory module 110 displays will change based upon the lighting arrangement at each intersection, in other words, the user with the green light will receive a first instruction set that instructs the sensory module 110 to perform the “go” sequence and the user with the red light will receive a second instruction set that instructs the sensory module 110 to perform the “stop” sequence, and both users will receive a third instruction set to implement the “go” and “stop” sequence concurrently. Similarly, the sensory module 110 may be instructed to display a green light (or any other suitable color light) when the vehicle is allowed to pass through a toll booth, for example, a sensory module 110 in a car that is equipped with a FasTrak or FasTrak type device will display green when the FasTrak has been detected and the toll fee has been collected.

In a third exemplary usage scenario, as shown in FIG. 6, the system 100 and method S100 of the preferred embodiments may be used on the road. For example, a bus with an attached sensory module 110 that includes a display for an advertisement or advisory may receive an information set along the road from a first signal emitter 120, for example, an updated advertisement or advisory. Elsewhere, a second signal emitter 130 may instruct the sensory module 110 to implement the sequence received. In this example, the first information set may include an advertisement for a bank, and the second signal emitter 130 may be located substantially close to the bank and may emit an implementation information set to display the advertisement, functioning as a localized advertisement for the bank. In this example, the sensory module 110 may function to store a series of information sets from the first signal emitter 120, for example, information sets I, II, III, and IV, and the second signal emitter 130 may function to reference a particular information set, for example, “Implement information set I”

In a fourth exemplary usage scenario, as seen in FIG. 7, the system 100 and method S100 of the preferred embodiments may be used on objects that are not typically equipped data networks, for example, a solar panel, windmill, or any other type of object that may be difficult to communicate updated information to otherwise. This is particularly applicable in scenarios where there are substantially large fields of solar panels and/or windmills with a substantially large surface area that may be used to broadcast information (similar to a large screen). The sensory modules 110 may be arranged among the solar panels and/or windmills, for example, on the blades of a windmill or on the edges of solar panels, and the first and second signal emitters 120 and 130 may function to emit information sets to the sensor modules 110, similar to the first exemplary usage scenario described above, and the sensory modules 110 may cooperate to display information. In the variation applied to a solar panel, each output element 114 may be managed as a pixel of a large screen. In the variation applied to the windmill, the output elements 114 may be arranged on the blades of the windmill such that, as the blades turn, the lights emitted by the output elements 114 may cooperate to form an image. In this variation, the sequence of light emitted by the output elements 114 is preferably based on the speed of rotation of the windmill. However, any other suitable arrangement of the output elements may be used. In this exemplary usage scenario, multiple sensory modules 110 may be arranged on one unit of a solar panel windmill. Alternatively, each unit of solar panel or windmill may be regarded as a single sensory module 110. In this variation, each sensory module 110 may include a plurality of output elements 114. However, any other suitable arrangement of the sensory modules in the third exemplary usage scenario may be used.

In a fifth exemplary usage scenario, the user may be distributed a sensory module 110 that has been loaded with an instruction set based on the destination of the user within the a medical facility upon check-in into the medical facility, for example, the radiology department, and the sensory module 110 exhibits a light attribute that indicates to medical facility workers the destination of the patient, thus indicating to the medical facility workers if the user is heading towards the correct location within the medical facility, for example, if the user misunderstood directions, instead of going to the radiology department, he or she may mistakenly enter the maternity ward, and a passing medical facility worker will quickly notice this mistake by looking at the sensory module 110 and can quickly direct the user to the correct location. Alternatively, the sensory module 110 may change light attributes based upon the path taken by the user. For example, second emitters 130 may be located throughout the medical facility communicates with the sensory module 110 to determine the destination of the user and that will instruct the sensory module 110 to emit a “wrong direction” indication if the user on the wrong path. For example, if the patient is to go to the radiology department and is taking the correct path towards the radiology department, the sensory module 110 may emit a green light. If the patient takes a wrong turn or goes to the wrong floor of the building, the sensory module 110 may emit a red light, indicating to the user that the wrong path was taken and that he or she may backtrack or ask for assistance.

In a sixth exemplary usage scenario, because of first and second emitters 120 and 130 preferably provide a direction based signal that is received by the sensory emitters 1110, a sensory module 110 may detect attributes of the received signals from the first and/or second emitters 120 and 130 to determine where the sensory emitter 110 is located within the space. For example, if the detected signal from the first and/or second emitter 120 and 130 is of a lower magnitude and/or wavelength, the sensory module 110 may determine that the first and/or second emitter 120 and 130 is substantially far away. Similarly, if the sensory module 110 may detect only a reflected signal with no direct signal and determine that the first and/or second emitter 120 and 130 is located where is not direct line of sight to the sensory module 110. The receiver 112 of the sensory module 110 may also detect the direction from which the data signal from the first and/or second emitter 120 and 130 is received to determine the location of the first and/or second emitter 120 and 130 relative to the sensory module 110. For example, the receiver 112 may include a plurality of receiver modules, a first receiver module that receives signals from 0 to 30 degrees relative to the sensory module 110, a second receiver module that receives signals from 30 to 60 degrees relative to the sensory module 110, and a total of twelve receiver modules to allow receipt of signals at all 360 degrees relative to the sensory module 110. However, any other suitable arrangement of the receiver 112 may be used to allow the sensory module 110 to determine where the sensory emitter 110 is located within the space may be used.

The system 100 and method S100 for transmitting information within a space is preferably one of the variations described above, but may alternatively be a combination of the variations described above or any other suitable variation. The system 100 and method S100 may also be used to transmit any other suitable types of information in any other suitable types of usage scenarios.

As a person skilled in the art will recognize from the previous detailed description and from the figures and claims, modifications and changes can be made to the preferred embodiments of the invention without departing from the scope of this invention defined in the following claims.

We claim:

1. A system for transmitting information within a space, comprising:
a plurality of sensory modules that each include a data signal receiver and an output element and that are arranged within the space;
a first signal emitter that emits a data signal of a first broadcast breadth into the space and includes a direction modifier that directs:
a data signal including a first information set with information on the operation of the output element to a first portion of the space to be received by a first sensory module substantially within the first portion of the space, and
a data signal including a second information set with information on the operation of the output element to a second portion of the space to be received by a second sensory module substantially within the second portion of the space; and
a second signal emitter that emits a data signal of a second broadcast breadth substantially larger than the first broadcast breadth that includes a third information set with information on the implementation of the first and second information sets to both the first and second portions of the space to be received by first and second sensory modules.

2. The system of claim 1, further comprising a processor coupled at least one of the first and second emitters that is configured to determine the first, second, and third information sets to be emitted to the first and second sensory modules.

3. The system of claim 2, wherein the processor is configured to detect the state of each of the sensory modules and wherein the processor is configured to modify at least one of the first, second, and third information sets based on the detected activity.

4. The system of claim 3, wherein the sensory module includes a motion sensor that communicates the motion of the sensory module to the processor.

5. The system of claim 4, wherein the motion sensor is an accelerometer.

6. The system of claim 2, wherein the processor is configured to detect the location of each of the sensory modules and wherein the processor is configured to modify at least one of the first, second, and third information sets based on the detected activity.

7. The system of claim 6, wherein the processor receives an image of the sensory modules within the space and determines the location of the sensory modules based on the image.

8. The system of claim 4, wherein the sensory modules include signal emitters that emit a signal and wherein the first and second signal emitters include signal receivers that detect signals from the sensory modules and communicate the signals to the processor.

9. The system of claim 8, wherein the sensory modules include signal reflectors that reflect the data signals from the first and second signal emitters, wherein the reflected data signals are detectable by the signal receivers of the first and second signal emitters.

10. The system of claim 1, wherein the first and second signal emitters are separate devices.

11. The system of claim 1, wherein the first and second emitters move substantially within the space.

12. The system of claim 1, wherein the second broadcast breadth includes both the first and second portions of the space and both the first and second sensory modules receive the third information set at substantially the same time.

13. The system of claim 1, wherein each sensory module further includes a processor to interpret the received data signals.

14. The system of claim 13, wherein the processor further detects the state of the sensory module and adjusts the operation of the output element based on the state of the sensory module.

15. The system of claim 13, wherein the processor further detects the location of the sensory module within the space based on the attributes of the received data signals.

16. The system of claim 1, wherein the first and second signal emitters emit directional data signals.

17. The system of claim 16, wherein the first and second signal emitters emit infrared data signals.

18. The system of claim 16, wherein each sensory module further includes a signal interpreter configured to distinguish between a data signal direct from the first and second signal emitter and a reflected data signal.

19. The system of claim 18, wherein the signal interpreter includes a processor configured to process the received instruction sets, wherein the processor is configured to disregard an information set from a reflected data signal.

20. The system of claim 1, wherein the output element is a light and wherein the first and second information sets include operation parameters of the light.

21. The system of claim 20, wherein the information sets include operation parameters of the light selected from the group consisting of: light on, light off, light color, and light intensity.

22. The system of claim 1, wherein the output element is a vibration element and wherein the first and second information sets include operation parameters of the vibration module.

23. The system of claim 22, wherein the information sets include operation parameters of the vibration module selected from the group consisting of: vibration on, vibration off, vibration intensity, and vibration frequency.

24. The system of claim 1, wherein the space provides a user experience to a plurality of users, and wherein the plurality of sensory modules is distributed to the users of the user experience.

25. The system of claim 24, further including a central control that communicates with the first and second signal emitters and provides the first, second, and third information sets to be transmitted to the sensory modules, and wherein the space further includes a control system for the user experience of the space, wherein the central control is integrated into the control system for the user experience of the space.

26. The system of claim 25, wherein the control system of the user experience of the space includes control for the lighting of the space.

27. The system of claim 1, wherein each of the sensory modules further includes a storage device that stores an information set received from the first and second signal emitters.

28. The system of claim 1, wherein the third information set includes timing for the implementation of the first and second instruction sets.

29. The system of claim 28, wherein each of the sensory modules include a timing module that is substantially synchronized to other sensory modules and wherein the timing information in the third information set includes a time to implement the first and second information sets relative to the time of the timing module.

30. The system of claim 1, wherein the third information set includes a trigger to initiate the implementation of the first and second information sets upon receipt by the first and second sensory modules.

31. A method for transmitting information within a space, comprising the steps of:
arranging a plurality of sensory modules that each include a data signal receiver and an output element within the space;
emitting a data signal with a first broadcast breadth with a first information set with information on the operation of the output element to a first portion of the space to be received by a first sensory module within the first portion of the space;
emitting a data signal of the first broadcast breadth with a second information set with information on the operation of the output element to a second portion of the space to be received by a second sensory module within the second portion of the space; and
emitting a data signal with a second broadcast breadth substantially larger than the first broadcast breadth with a third information set with information on the implementation of the first and second information sets to both the first and second portions of the space to be received by the first and second sensory modules.

32. The method of claim 31, wherein the step of emitting a data signal with a second broadcast breadth includes emitting a data signal with a broadcast breadth that includes both the first and second portion of the space and wherein the first and second sensory modules receive the third information set at substantially the same time.

33. The method of claim 31, wherein the step of emitting a data signal with a second broadcast breadth with a third information set includes emitting a trigger in the third information set that triggers the implementation of the first and second information sets upon receipt of the third information set by the first and second sensory modules.

34. The method of claim 31, wherein the step of emitting a data signal with a second broadcast breadth with a third information set includes emitting information in the third information set that includes timing for the implementation of the first and second information sets.

35. The method of claim 34, wherein the timing of the implementation of the first instruction set and the timing of the implementation of the second instruction set are substantially identical.

36. The method of claim 31, further comprising the step of substantially synchronizing a timing reference between each of the sensory modules.

37. The method of claim 31, further comprising storing a received information set in each sensory module.

38. The method of claim 31, further comprising detecting the state of a sensory module and adjusting the operation of the output element of the sensory module based on the detected state.

39. The method of claim 38, wherein the step of adjusting the operation of the output element of the sensory module based on the detected state includes adjusting at least one of the first, second, and third information sets received by the sensory module.

40. The method of claim 31, further comprising detecting the location of the sensory module within the space based on the attributes of at least one of the received data signals.
